(19) United States
(12) Patent Application Publication
(10) Pub. No.: US 2026/0236129 A1
(43) Pub. Date: Aug. 13, 2026

(54) METHOD, TOUCH SENSITIVE PROCESSING APPARATUS, AND TOUCH SYSTEM FOR DETECTING POSITION WHERE ACTIVE STYLUS APPROACHIES OR TOUCHES

(71) Applicant: EGALAX_EMPIA TECHNOLOGY INC., Taipei City (TW)

(72) Inventor: CHIN-FU CHANG, Taipei City (TW)

(21) Appl. No.: 19/536,294

(22) Filed: Feb. 11, 2026

Related U.S. Application Data
(60) Provisional application No. 63/756,825, filed on Feb. 11, 2025.

(30) Foreign Application Priority Data
Dec. 5, 2025 (TW) 114147844

(51) Int. Cl. G06F 3/044; G06F 3/0354

(52) U.S. Cl. CPC G06F 3/0446; G06F 3/03545; G06F 3/0442

(57) ABSTRACT

A method for detecting approaching or touching position of active stylus, comprising: detecting electrical signals via touch electrodes of a touch screen to calculate a first position of the active stylus during a first period; detecting electrical signals via the touch electrodes to calculate a second position of the active stylus during a second period; calculating an inclination angle between the active stylus and the touch screen according to the first and the second positions; calculating a direction and a vector of the direction according to the first and the second positions; and calculating a tip position according to the vector and a value of a first function of the inclination angle when a tip of the active stylus touches the touch screen.

### CROSS REFERENCE TO RELATED PATENT APPLICATION

This patent application is based on a provisional patent application No. 63/756,825 filed on February 11, 2025, and a Taiwan, R.O.C. patent application No. 114147844 filed on December 5, 2025.

### FIELD OF THE INVENTION

The present invention relates to active stylus, and more particularly, to calculation of inclination angle and tip position of active stylus.

### BACKGROUND OF THE INVENTION

Touch panel or screen (hereinafter touch screen) already becomes one of major input/output devices of modern electronic systems. In order to get more precise control experience, stylus is used to replace finger as a touch control tool. In addition, a stylus which actively transmits signals can have the touch screen enjoy greater SNR (signal to noise ratio), the preciseness of its touch control is better than the passive stylus which cannot actively transmit signals.

For electronic systems, if it is able to detect an axial direction (direction) and an inclination angle of an active stylus with respect to the touch screen, more control options can be provided to a user of the active stylus to let the user have more input options and conveniences. Hence it exists a need of a new structure of an active stylus and associated method for controlling the electric signals as well as a detecting method of the active stylus, so as that the direction and/or the inclination angle of the active stylus with respect to the touch screen can be detected in addition to a position.

### SUMMARY OF THE INVENTION

According to an embodiment of the present application, a method for detecting position where active stylus approaches or touches is provided. The method comprising: detecting electric signals via multiple touch electrodes of a touch screen during a first period for calculating a first position of an active stylus; detecting electric signals via the multiple touch electrodes of a touch screen during a second period for calculating a second position of the active stylus; calculating an inclination angle between the active stylus and the touch screen according to the first position and the second position; calculating an orientation and its vector according to the first position and the second position; and when a tip of the active stylus touches the touch screen, calculating a tip position according to the vector and a value of a first function of the inclination angle.

Preferably, in order to determine whether a tip of the active stylus is in contact with the touch screen, the method further comprises one of following steps to determine whether a tip of the active stylus is in contact with the touch screen: demodulating the electric signals to obtain pressure information on a tip of the active stylus; and determining whether the touch screen is pressed near the first position according to a mutual capacitance sensing image of the multiple touch electrodes.

Preferably, in order to obtain a projected position when the active stylus floating on the touch screen, the method further comprises: when the tip of the stylus is not in contact with the touch screen, calculating a vertically projected position of the tip according to the vector and a value of a third function.

Preferably, in order to obtain a projected position when the active stylus floating on the touch screen, wherein when the tip of the stylus is not in contact with the touch screen, the method further comprises: estimating a distance between the tip and the touch screen according to a sum of the electric signals; calculating a value of a second function according to the distance and the inclination angle; and calculating an extended position where a body axis of the active stylus intersects with the touch screen according to the vector and the value of the second function.

Preferably, in order to estimate the distance between the tip and the touch screen, wherein the method further comprises: obtaining a first-axis sensing array via multiple second electrodes in parallel of the multiple touch electrodes and a second-axis sensing array via multiple first electrodes in parallel of the multiple touch electrodes during the first period; retrieving one or more first elements from the first-axis sensing array related to the first position; retrieving one or more second elements from the second-axis sensing array related to the first position; calculating a sum of the one or more first elements and the one or more second elements; and setting the distance between the tip and the touch screen according to the sum.

Preferably, in order to estimate the distance between the tip and the touch screen, wherein the method further comprises: setting the distance between the tip and the touch screen as a maximum, when the sum is less than a sum threshold.

Preferably, in order to filter out interferences from noises, wherein the values of the one or more first elements and the values of the one or more second elements exceed a threshold.

Preferably, in order to estimate the distance between the tip and the touch screen more thoughtfully, wherein the method further comprises: obtaining a second-period first-axis sensing array via the multiple second electrodes in parallel of the multiple touch electrodes and a second-period second-axis sensing array via the multiple first electrodes in parallel of the multiple touch electrodes during the second period; retrieving one or more first elements from the second-period first-axis sensing array related to the second position; and retrieving one or more second elements from the second-period second-axis sensing array related to the second position.

According to an embodiment of the present application, a touch system for detecting position where active stylus approaches or touches is provided. The touch system comprising the touch sensitive processing apparatus; the touch screen; and the active stylus.

The stylus and corresponding touch sensitive processing apparatus and method of the present application provide that the active stylus selectively lets potential of the shielding ring surrounding the tip electrode being floating or grounded when the electrical signals continuously emitted by the tip electrode of the active stylus. As a result, the touch sensitive processing apparatus can calculate an inclination angle between the active stylus and the touch screen and a direction or an orientation the active stylus projected on the touch screen according to two positions caused by the change of the potential of the shielding ring. Moreover, a tip position of the active stylus can be more precisely calculated according to the inclination angle of the touch screen. Because the user more easily sees the extended position or the vertically projected position of the tip, unlike the line-of-sight to the first position or the tip position may be blocked by the active stylus or the finger. Thus, it can provide better user experience.

Because the active stylus only has to control the potential of the shielding ring being floating or grounded and the electrical signals are continuously emitted from the tip electrode, the relevant circuit design would be simplified to reduce manufacturing cost. Moreover, because the circuit design is simpler, the active stylus is more shock resistant and drop resistant, the user may think that the active stylus more robust, durable, and reliable.

### BRIEF DESCRIPTION OF THE DRAWINGS

The advantages and spirit related to the present invention can be further understood via the following detailed description and drawings.

FIG. 1 depicts a block diagram of a touch system 100 in accordance with an embodiment of the present application.

FIG. 2 depicts a diagram of an active stylus 130 in accordance with an embodiment of the present application.

FIG. 3 is a front view of an active stylus 130 in accordance with an embodiment of the present application.

FIG. 4 depicts a block diagram of an active stylus 130 in accordance with an embodiment of the present application.

FIG. 5 shows a diagram of electrical signal periods in accordance with an embodiment of the present application.

FIG. 6A depicts a sensing image during a first period 530 in accordance with an embodiment of the present application.

FIG. 6B depicts a sensing image during a second period 540 in accordance with an embodiment of the present application.

FIG. 6C shows a sensing image by overlapping the sensing images as shown in FIG. 6A and FIG. 6B.

FIG. 7 shows a diagram representing the vector 650 being projected on the surface of the touch screen 120 as shown in FIG. 6C.

FIG. 8 depicts a magnified view near the touch point of the tip electrode 210 as shown in FIG. 7.

FIG. 9 depicts a variant of the embodiment as shown in FIG. 8.

FIG. 10 is a variant of the embodiment as shown in FIG. 9.

FIG. 11 depicts a flowchart diagram of a method 1100 for detecting position where active stylus approaches or touches in accordance with an embodiment of the present application.

FIG. 12 depicts a flowchart diagram of a method 1200 for estimating a distance between a tip and a touch screen in accordance with an embodiment of the present application.

### DETAILED DESCRIPTION OF THE PREFERRED EMBODIMENT

To make the objectives, technical solutions, and advantages of this application clearer, the technical solutions of this application will be described in detail below. Obviously, the described embodiments are only a part of the embodiments of this application, and not all of them. Based on the embodiments of this application, all other implementation methods obtained by those skilled in the art without creative effort are within the scope of protection of this application.

The terms "first," "second," "third," etc. (if present) in the specification, claims, and drawings of this application are used to distinguish similar objects and are not necessarily used to describe a specific order or sequence. It should be understood that the objects described are interchangeable where appropriate. In the description of this application, "plural" means two or more, unless otherwise expressly and specifically defined. Furthermore, the terms "comprising" and "having," and any variations thereof, are intended to cover non-exclusive inclusion. Some block diagrams shown in the drawings are functional entities and do not necessarily correspond to physically or logically independent entities. Such functional entities may be implemented in software, in one or more hardware circuits or integrated circuits, or in different network and/or processor devices and/or microcontroller devices.

In the description of this application, it should be noted that, unless otherwise explicitly specified and limited, the terms "installation," "connection," and "linking" should be interpreted broadly. For example, they can refer to fixed connections, detachable connections, or integral connections; they can refer to mechanical connections, electrical couplings, or connections that allow for communication; they can refer to direct connections or indirect connections via an intermediate medium; and they can refer to the internal communication of two components or the interaction between two components. Those skilled in the art can understand the specific meaning of the aforementioned terms in this application based on the specific circumstances. To make the objectives, features and advantages of this application more apparent and understandable, the application will be further described in detail below with reference to the drawings and specific embodiments.

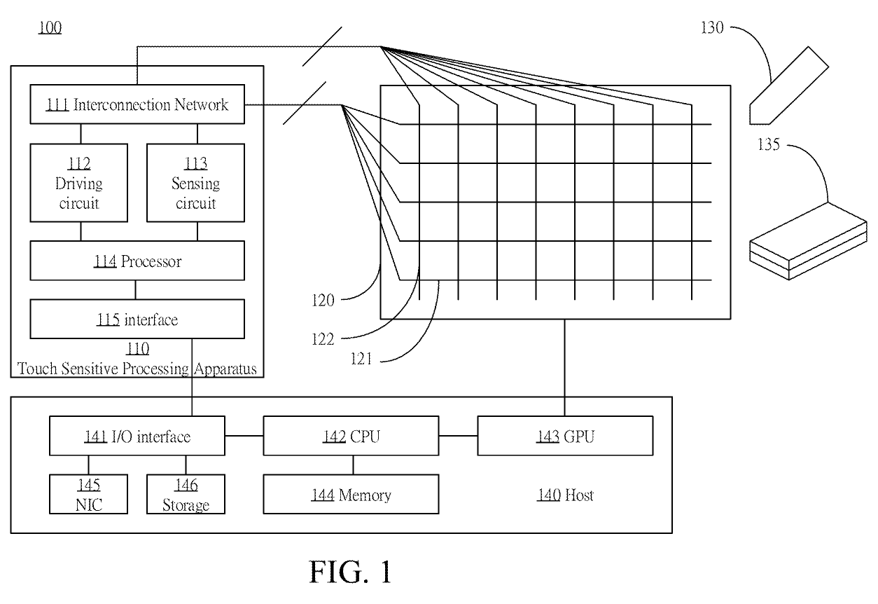

Please refer to FIG. 1, which depicts a block diagram of a touch system 100 in accordance with an embodiment of the present application. The touch sensitive system 100 may be a common desktop, laptop, tablet personal computer, industrial control computer, smartphone or any other computer system fulfilling touch sensitive functions.

The touch system 100 may comprise a touch sensitive processing apparatus 110, a touch screen 120 which connects to the touch sensitive processing apparatus 110, and a host 140 which connects to the pressure sensitive processing apparatus 110. The touch system 100 may further comprises one or more styli 130 and/or touch board eraser 135. The touch screen 120 comprises multiple first electrodes 121 in parallel to a first axis and multiple second electrodes 122 in parallel to a second axis. The first electrodes 121 intersect with the second electrodes 122 to form multiple sensing points or areas. Similarly, the second electrodes 122 intersect with the first electrodes 122 to form multiple sensing points or areas. In some embodiments, the first electrodes 121 may be referred to as first touch electrodes 121; the second electrodes 122 may be referred to as second touch electrodes 122. Collectively, the first electrodes 121 and the second electrodes 122 are referred to as touch electrodes. In some embodiments involving the touch screen 120, the first electrodes 121 and the second electrodes 122 are made of transparent materials. The first electrodes 121 and the second electrodes 122 may be in the same electrode layer where conductive plates of each of the first electrodes 121 or the second electrodes 122 are connected by bridging. The first electrodes 121 and the second electrodes 122 may be disposed in two overlapping electrode layers. Unless described specifically, the present application may be applicable to the embodiments include single electrode layer and the embodiments include multiple electrode layers. The first axis and the second axis are usually perpendicular to each other. However, the present application does not limit that the first axis must be perpendicular to the second axis. In one embodiment, the first axis may be a horizontal axis or a refresh axis of the touch screen 120. The first electrodes 121 and/or the second electrodes 122 may include multiple conductive plates. Person having ordinary skill in the art may refer to multiple patent applications of the Applicant to understand various embodiments of the first electrodes 121 and/or the second electrodes 122.

The touch sensitive processing apparatus 110 may comprise following hardware circuit modules: an interconnection network module 111, a driving circuit module 112, a sensing circuit module 113, a processor module 714, an interface module 115. The touch sensitive processing apparatus 110 may be implemented in a single chip of integrated circuits, which may encapsulate one or more dies. The touch sensitive processing apparatus 110 may be implemented by multiple chips of integrated circuits and a circuit board connecting these chips. The touch sensitive processing apparatus 110 may be implemented in the same chip which comprise the host 140. In other words, the application does not limit how the touch sensitive processing apparatus 110 implements.

The interconnection network module 111 is configured to connect one or more first electrodes 121 and/or the second electrodes 122 of the touch screen 120, respectively. The interconnection network module 111 may receive control commands of the processor module 114 for connecting the driving circuit module 112 with any one or more touch electrodes and for connecting the sensing circuit module 113 with any one or more touch electrodes. The interconnection network module 111 may comprise a combination of one or more multiplexers to fulfill the mentioned functions.

The driving circuit module 112 may comprise clock generator, frequency divider, frequency multiplier, phase lock loop, power amplifier, DC-DC voltage converter, regulator and/or filter, which is configured to provide driving signal to any one or more touch electrodes via the interconnection network module 111 according to control commands of the processor module 114. The driving signal may be modulated by kinds of analog or digital modulations for carrying some messages. The modulations include but not limit to frequency modulation (FM), phase modulation, amplitude modulation, dual sideband modulation (DSB), single sideband module (SSB-AM), vestigial sideband modulation, amplitude shift keying (ASK), phase shift keying (PSK), quadrature amplitude modulation (QAM), frequency shift keying (FSK), continuous phase modulation (CPM), code division multiple (CDMA), time division multiple access (TDMA), orthogonal frequency division multiplexing (OFDM), pulse width modulation (PWM) and etc. The driving signal may include one or more square waves, sinuous waves, or any modulated waves. The driving circuit module 112 may include one or more channel. Each channel may be connected to any one or more touch electrodes via the interconnection network module 111.

The sensing circuit module 113 may comprise integrator, sampler, clock generator, frequency divider, frequency multiplier, phase lock loop, power amplifier, operational amplifier, multiplier, DC-DC voltage converter, regulator and/or filter, which is configured to sense on any one or more touch electrodes via the interconnection network module 111 according to control commands of the processor module 114. When the touch signal is transmitted from one of the touch electrodes, another touch electrode may induce the touch signal. And the sensing circuit module 113 may demodulate the induced touch signal by another touch electrode in accordance with the modulation method performed on the driving signal by the driving circuit module 112 in order to restore the messages carried by the driving signal. The sensing circuit module 113 may include one or more channels. Each channel may be connected to any one or more touch electrodes via the interconnection network module 111. At the same time, each channel may simultaneously perform sensing and demodulation.

In one embodiment, the driving circuit module 112 and the sensing circuit module 113 may include analog front-end (AFE) circuits. In another embodiment, in additional to the AFE circuits, the driving circuit module 112 and the sensing circuit module 113 may include digital back-end (DBE) circuits. If the driving circuit module 112 and the sensing circuit module 113 include only the AFE circuits, the DBE circuits may be implemented in the processor module 114.

The processor module 114 may include a digital signal processor for connecting the AFE circuits or the DBE circuits of the driving circuit module 112 and the sensing circuit module 113, respectively. The processor module 114 may include an embedded processor, non-volatile memories, and volatile memories. Normal or real-time operating system (OS) and their application programs may be stored in the non-volatile memories. The OS and the application programs include multiple instructions and data. The processor (including the embedded processor and the digital signal processor) may execute the instructions for controlling other modules including the interconnection network module 111, the driving circuit module 112, the sensing circuit module 113 and the interface module 115 of the pressure sensitive processing apparatus 110. For examples, the processor module 114 may comprises processors widely adopted in the industry such as 8051 series, Intel i960 series, ARM Cortex-M series and etc. The present application does not limit types and numbers of processor cores included in the processor module 114.

The instructions and data may be used to implement each of steps mentioned in the present application and flows and methods constructed by the steps. Some instructions may be executed independently inside the processor module 114, for examples, arithmetic and log operation instructions. Other instructions may be used to control other circuits of the touch sensitive processing apparatus 110. These instructions may include input/output interfaces of the processor module 114 to control other circuits. Other circuits may provide information via the input/output interface of the processor module 114 to the OS and/or application programs executed by the processor module 114. Persons having ordinary skill in the art should have common knowledge of computer organization and architecture which enabling them to understand that the flows and methods provided by the present application can be realized by the circuits and the instructions.

The interface module 115 may include kinds of serial or parallel bus, such as universal serial bus (USB), I²C, peripheral component interconnect (PCI), PCI-Express, IEEE 1394 and other industrial standard input/output interface. The touch sensitive processing apparatus 110 connects to the host 140 via the interface module 115.

The non-volatile memory may comprise rewritable memory, e.g., EEPROM or flash memory which keep memory content when electric power is cut. The processor module 114 can load and execute firmware stored in the non-volatile memory to realize touch sensitive functions. The firmware may include real-time operating system as well as corresponding instruction data for the operations of the processor module 114. In one embodiment, the programs and data included in the firmware can be used by the touch sensitive processing apparatus 110 to realize the embodiments provided by the present application.

The touch system 100 may include one or more styli 130 and/or touch board eraser 135. The stylus 130 or touch board eraser 135 may be a transmitter which transmits electrical signals. It may be an active transmitter which actively transmits electric signals, a passive transmitter which passively transmit electrical signals, or a responsive transmitter which transmits electrical signal in response to external electric signals. The stylus 130 or the touch board eraser 135 may comprise one or more electrodes which are configured to receive electrical signals came from the touch screen 120 synchronously or asynchronously or to transmit electrical signals to the touch screen 120 synchronously or asynchronously. The electrical signals may be modulated in one or more aforementioned modulations.

The stylus 130 or the touch board eraser 135 may be conductor which is used to transmit driving signal or to connect to ground potential via hand or body of its user. The stylus 130 or the touch board eraser 135 can connect with the I/O interface module 141 of the host 140 or with other module via the I/O interface module 141 by wire or wirelessly.

The touch sensitive processing apparatus 110 is able to detect one or more externally conductive object such as finger and palm of human body or passive stylus 130 or touch board eraser 135 via the touch screen 120. It may be also able to detect active stylus 130 or touch board eraser 135 which actively transmit electrical signals. The touch sensitive processing apparatus 110 is able to detect externally conductive object by utilizing mutual-capacitance principle or self-capacitance principle. The stylus 130 or touch board eraser 135 as well as the touch sensitive processing apparatus 110 may transmit messages via the electrical signals modulated in abovementioned methods and demodulate the messages by corresponding demodulation methods. The touch sensitive processing apparatus 110 is able to detect information such as one or more approaching or touching positions, sensor status (e.g., pressure sensor or button), directions, or inclination angles of the styli 130 or the touch board eraser 135 according to the detected electrical signals.

The host 140 is a main apparatus for controlling the touch system 100. It may comprise an input/output interface module 141 for connecting the interface module 115, a central processing unit (CPU) module 142, a graphics processor module 143, a memory module 144 connects to the CPU module 142, a network interface module 145 and a storage module 146 connect to the input/output interface module 141.

The storage module 146 comprises non-volatile memory. Common examples are hard disks, electronic erasable rewritable read only memory (EEPROM), or flash memory. The storage module 146 may store a normal operating system and application programs executable under the operating system. The network interface module 145 may comprise wired or wireless hardware network interface. The network interface module 145 may be compliant to common industrial standards such as IEEE 802.11 Wireless Local Area Network, IEEE 802.3 Local Area Network, 3G, 4G and/or 5G wireless telecommunication standards, Bluetooth wireless communication standards, and etc.

The CPU module 142 may directly or indirectly connects to the input/output interface module 141, the graphics processor module 143, the memory module 144, the network interface module 145 and the storage module 146. The CPU module 142 may comprise one or more processor or processor cores. Common processors may include Intel, AMD, VIA’s x86 and x64 instruction set architecture (ISA) processors, Apple, Qualcomm, MediaTek’s ARM ISA processors, or any other types of complex instruction set computer (CISC) or reduced instruction set computer (RISC) processors. The OS and application programs include multiple instructions and data corresponding to the instruction set. By executing these instructions, the CPU module 142 is able to control other modules of the touch system 100.

The optional graphics processor (GPU) module 143 is usually configured to handle computations with respect to graphics outputs. The graphics processor module 143 may connect to the touch screen 120 for controlling outputs of the touch screen 120. In some applications, the host 140 may have the CPU module 142 execute the computations with respect to graphics outputs, without dedicated handling of the graphics processor module 143.

The host 140 may comprise components or apparatus not shown in FIG. 1, for example, audio input/output interface, keyboard input interface, mouse input interface, track-ball input interface and/or any other hardware circuits. Persons having ordinary skill in the art should have common knowledge of computer organization and architecture. They can understand the touch system 100 disclosed by the present application is exemplary. Parts regarding to the inventive feature provided by the present application should be referred to the specification and the claim.

In the mutual-capacitance sensing, the driving circuit module 112 provides driving signals to one of the first electrodes 121 in a time-sharing manner. While the driving signals being provided in multiple occasions, the sensing circuit module 113 is required to perform multiple sensing on all the second electrodes 122 simultaneously in order to gather sensing information in multiple one-dimensional sensing arrays. Each of the one-dimensional sensing arrays comprises sensing results corresponding to each of the second electrodes 122. The multiple one-dimensional sensing arrays can form a two-dimensional array of sensing information or a sensing image according to a sequence of the first electrodes 121 which emitted the driving signals. According to the two-dimensional array of sensing information or the sensing image, the processor module 114 can detect whether there is an external conductive object approaching or touching the touch screen 120.

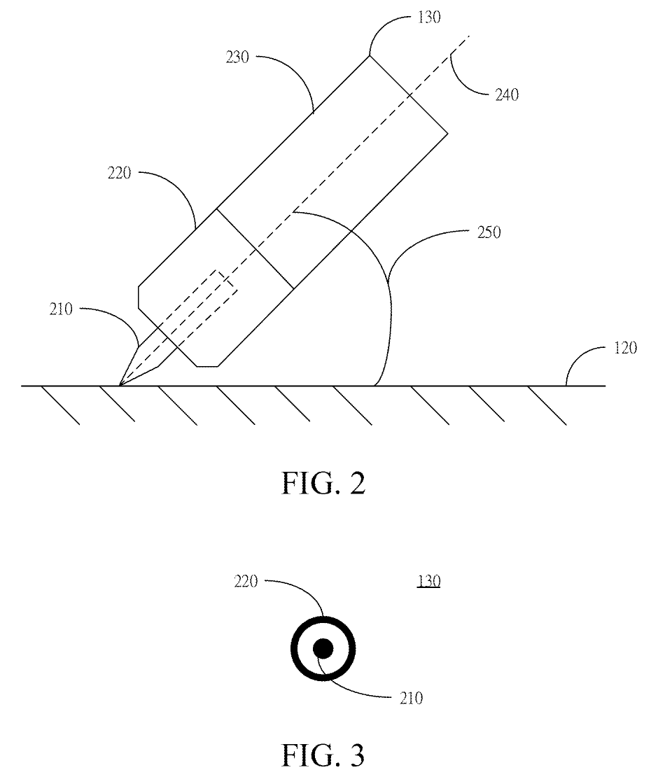

Please refer to FIG. 2, which depicts a diagram of an active stylus 130 in accordance with an embodiment of the present application. The active stylus 130 is configured to approach or touch the touch screen 120. The active stylus 130 may include a tip electrode 210, a shielding ring 220, a body 230, and a body axis 240. The body 230 is an elongated pen-like object with two ends. A line between the two ends is the body axis 240. The first end of the body 230 is the tip electrode 210.

The tip electrode 210 may be a rod shape object. One end of the rod-shape object serves as the tip may be a sharpened cone. The other end may be embedded into a first end of the body 230 in order to fix the tip electrode 210 to the first end of the body 230. In order to transmit electrical signals, the tip electrode 210 may be made of conductor. For example, the tip electrode 210 may include metal or graphite materials.

A shielding ring 220 may be installed to the body 230 near its first end. The shielding ring 220 is set behind the tip electrode 210 and surrounding the portion of the tip electrode 210 embedded into the body 230. In order to shield the electrical signals transmitted from the tip electrode 210, the shielding ring 220 may be connected to ground potential or a direct current voltage. Besides, the shielding ring 220 may not be connected to the ground potential or a direct current voltage. It may be set floating. When the voltage of the shielding ring 220 is floating, the electrical signals transmitted by the tip electrode 210 would be induced by the shielding ring 220. Thus, the shielding ring 220 would radiate the induced electrical signals as a result.

In one embodiment, in order to prevent user’s hand directly touching the shielding ring 220, dielectric material may be added to the outer surface of the shielding ring 220. In other words, in another embodiment, the shielding ring 220 may be installed beneath the outer surface of the body 230 nearby the first end for surrounding the tip electrode 210.

As shown in FIG. 2, when the active stylus 130 approaches or touches the touch screen 120, an inclination angle 250 between the body axis 240 of the active stylus 130 and the surface of the touch screen 120 would be presented. Even if the touch screen 120 is a curve surface screen, an inclination angle 250 is still presented between the tip electrode 210 of the active stylus 130 and a tangent of the curve surface of the touch screen 120. User can control the active stylus 130 in order to use the inclination angle 250 as an input parameter.

Please refer to FIG. 3, which is a front view of an active stylus 130 in accordance with an embodiment of the present application. FIG. 3 shows a perspective view from the first end of the body 230 to the body 230. The tip electrode 210 is in the middle. The tip electrode 210 is surrounded by the shielding ring 220. The tip electrode 210 is not in contact with the shielding ring 220.

Although in the embodiment as shown in FIG. 3, the cross section of the body 230 is circular, the present application does not require that the cross section of the body 230 must be circular. For example, the cross section of the body 230 may be regular N-gon, N may be an integer equals to or larger than 3. Similarly, the cross sections of the tip electrode 210 and/or the shielding ring 220 may not be circular. For example, the cross section of the tip electrode 210 and/or the shielding ring 220 may be regular N-gon, N may be an integer equals to or larger than 3. A person having ordinary skill in the art can understand that the present application does not limit the shapes of cross sections of the tip electrode 410, the shielding ring 220, and/or the body 230.

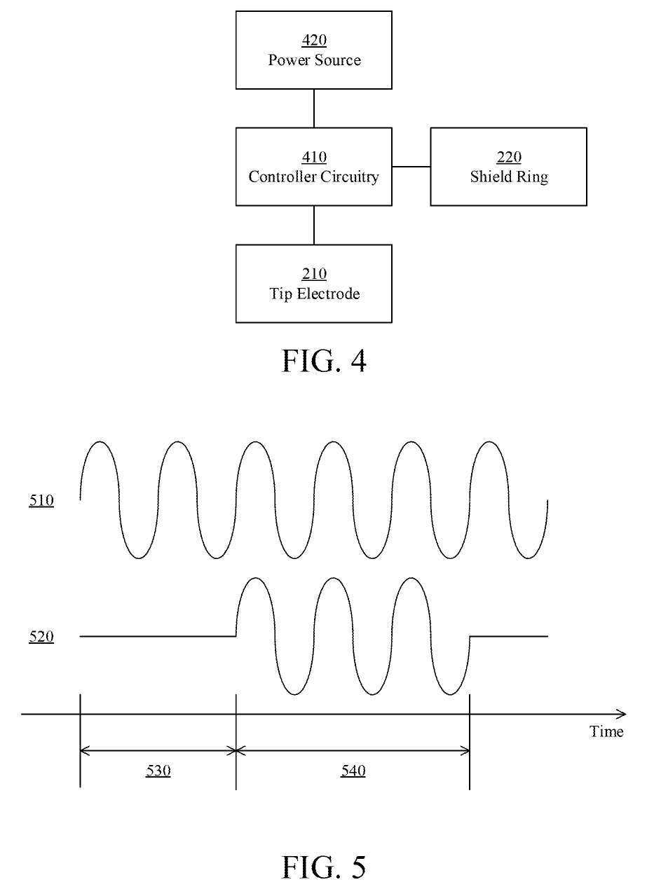

Please refer to FIG. 4, which depicts a block diagram of an active stylus 130 in accordance with an embodiment of the present application. The active stylus 130 may include a controller circuit 410 and a power source 420 supplying power to the controller circuit 410. The power source 420 may comprise various kinds of batteries, capacitors, and their voltage control circuits.

The controller circuits 410 may comprises electric components of the driving circuit module 112 as shown in FIG. 1. The controller circuits 410 is configured to generate electrical signals and to transmit the electrical signals to the tip electrode 210. Besides, the controller circuits 410 may selectively connect the shielding ring 220 to the ground potential or a DC voltage or let the potential of the shielding ring 220 being floating.

Please refer to FIG. 5, which shows a diagram of electrical signal periods in accordance with an embodiment of the present application. As shown in FIG. 5, there exist a first period 530 and a second period 540. The line 510 shows electrical signals emitted from the tip electrode 210. The line 520 shows electrical signals induced by the shielding ring 220.

During the first period 530, the controller circuits 410 transmits the electrical signals to the tip electrode 210 and has the shielding ring 220 connected with the ground potential or a DC voltage. Hence, the potential of the shielding ring 220 maintains stable.

During the second period 540, the controller circuits 410 transmits the electrical signals to the tip electrode 210 and has the potential of the shielding ring 220 being floating. Therefore, the potential of the shielding ring 220 floats with the induced electrical signals and further emits the induced electrical signals.

The present application does not limit the sequence of the first period 530 and the second period 540, the durations of the first period 530 and the second period 540, and a ratio of the durations of the first period 530 and the second period 540. However, the sequence, the durations, and the ratio of durations may be pre-determined.

Besides, the present application does not limit a ratio of numbers of the first period 530 and the second period 540. In one embodiment, a repetitive sequence may include following: a second period 540, a first period 530, a second period 540, a blanking period, a second period 540, a first period 530, the second period 540, and a blanking period. In an alternative embodiment, another repetitive sequence may include following: a first period 530, a second period 540, a first period 530, a blanking period, a second period 540, a first period 530, a second period 540, and a blanking period.

Besides, the controller circuit 410 may modulate the electrical signal in order to carry various kinds of messages. For examples, a message of pressure on the tip electrode 210, a message of status of a button of the active stylus 130, and a designated number of the active stylus 130 may be carried. When the touch sensitive processing apparatus 110 receives the electrical signals via the touch electrodes of the touch screen 120, the carried messages may be retrieved by demodulation. The present application does not limit the modulation types of the electrical signals. A person having ordinary skill in the art can understand that the electrical signals received by the touch sensitive processing apparatus 110 during the second period 540 which may be emitted directly from the tip electrode 210 or indirectly from the shielding ring 220 came from the tip electrode 210.

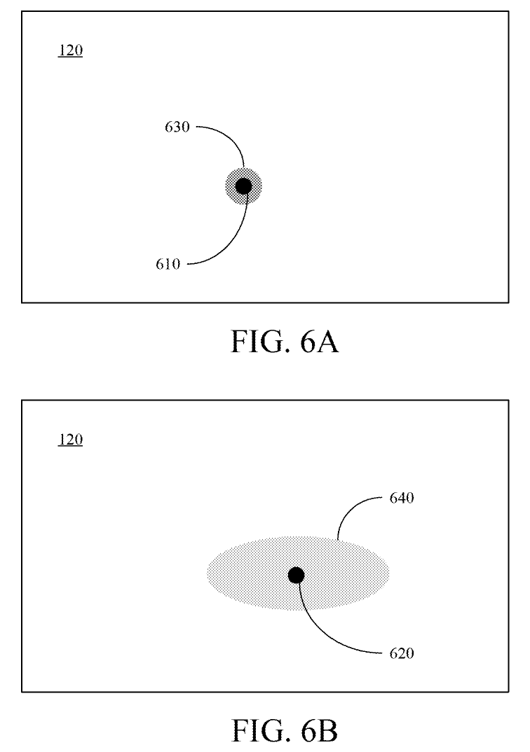

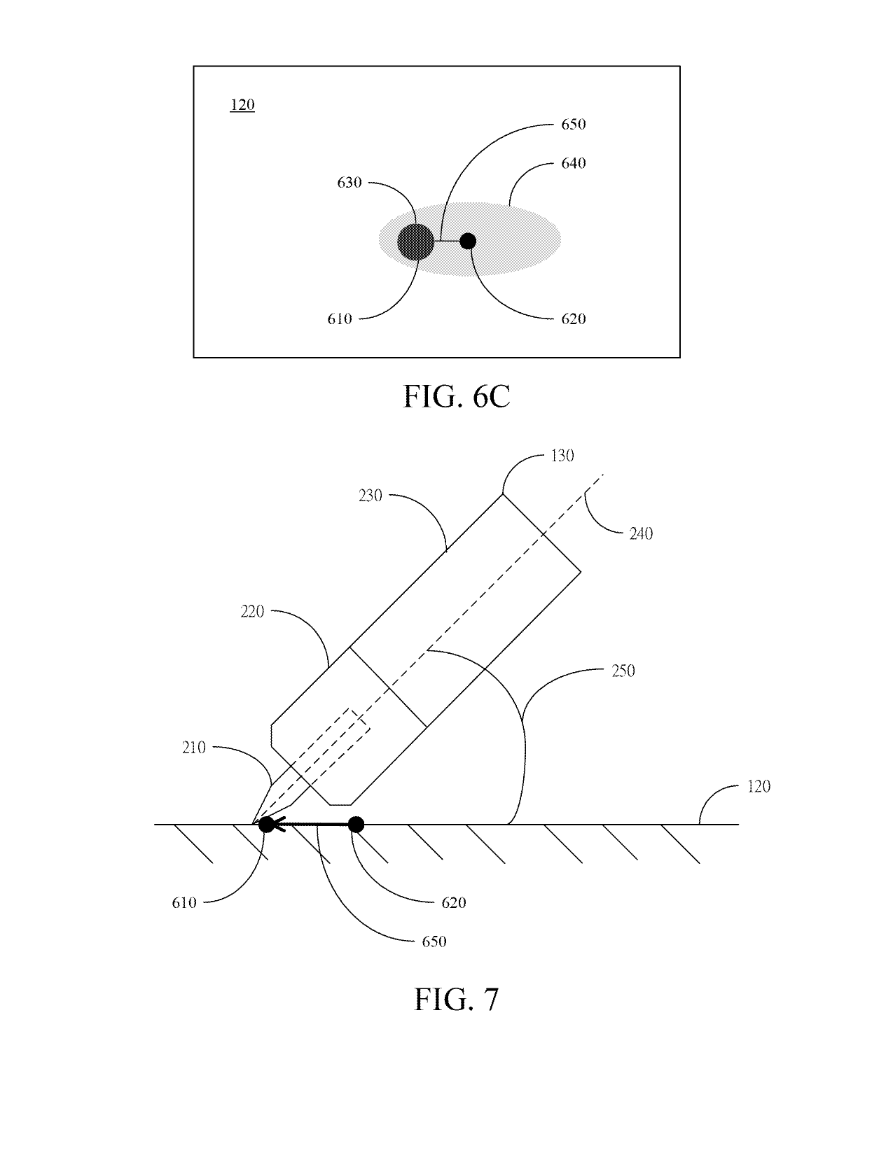

Please refer to FIG. 6A, which depicts a sensing image during a first period 530 in accordance with an embodiment of the present application. During the first period 530, the electrical signal emitted from the tip electrode 210 makes influence in a first influential area 630 of the touch screen 120. The touch sensitive processing apparatus 110 can calculate a first position 610 corresponding to the tip electrode 210 according to the electrical signals sensed by the touch electrodes in the first influential area 630. In other words, a gravity center or a mass center of the first influential area 630 is at the first position 610.

Please refer to FIG. 6B, which depicts a sensing image during a second period 540 in accordance with an embodiment of the present application. During the second period 540, the electrical signal emitted from the tip electrode 210 makes influence in a second influential area 640 of the touch screen 120. The size of the second influential area 640 depends on the body axis 240, i.e., the inclination angle 250. The touch sensitive processing apparatus 110 can calculate a second position 620 corresponding to the tip electrode 210 according to the electrical signals sensed by the touch electrodes in the second influential area 640. In other words, a gravity center or a mass center of the second influential area 640 is at the second position 620.

A person having ordinary skill in the art can understand that the touch sensitive processing apparatus 110 may form a second axis sensing array based on the electrical signals sensed by all the first electrodes 121. Similarly, the touch sensitive processing apparatus 110 may form a first axis sensing array based on the electrical signals sensed by all the first electrodes 122. The first axis positions of the first position 610 and the second position 620 can be calculated based on the first axis sensing array. The second axis positions of the first position 610 and the second position 620 can be calculated based on the second axis sensing array. Consequently, the first position 610 and the second position 620 can be determined.

Please refer to FIG. 6C, which shows a sensing image by overlapping the sensing images as shown in FIG. 6A and FIG. 6B. As shown in FIG. 6C, a vector 650 is formed by pointing from the second position 620 to the first position 610. The vector 650 is on the surface of the touch screen 120. It represents a vector projected from the active stylus 130 on the touch screen 120. The vector 650 further represents a direction of the active stylus 130. For example, the vector 650 points to left hand side. It represents the tip of active electrode 130 points to the left-hand side of FIG. 6C.

Please refer to FIG. 7, which shows a diagram representing the vector 650 being projected on the surface of the touch screen 120 as shown in FIG. 6C. Because relative positions between the tip electrode 210 and the shielding ring 220 are pre-determined, the length of the axis 240 between the tip electrode 210 and the shielding ring 220, the length of the vector 650, and the inclination angle would form a cosine relation. A value of the cosine function of the inclination angle 250 would be corresponding to a ratio between the length from the tip electrode 210 to the shielding ring 220 and the length of the vector 650. Because the length of the axis 240 between the tip electrode 210 and the shielding ring 220 and the length of the vector 650 are known, the touch sensitive processing apparatus 110 is able to calculate the inclination angle 250 of the active stylus 130 with respect to the touch screen 120.

A person having ordinary skill in the art can understand the inclination angle may be an angle between the axis 240 and a normal line where the tip electrode 210 touches the touch screen 210. These two angles may be interchangeable. A person having ordinary skill in the art can understand that the touch sensitive processing apparatus 110 can determine whether the tip electrode 210 touches the touch screen 120 according to the pressure value carried by the electrical signals. When the tip electrode 210 touches the touch screen 120, the pressure value shall not be zero.

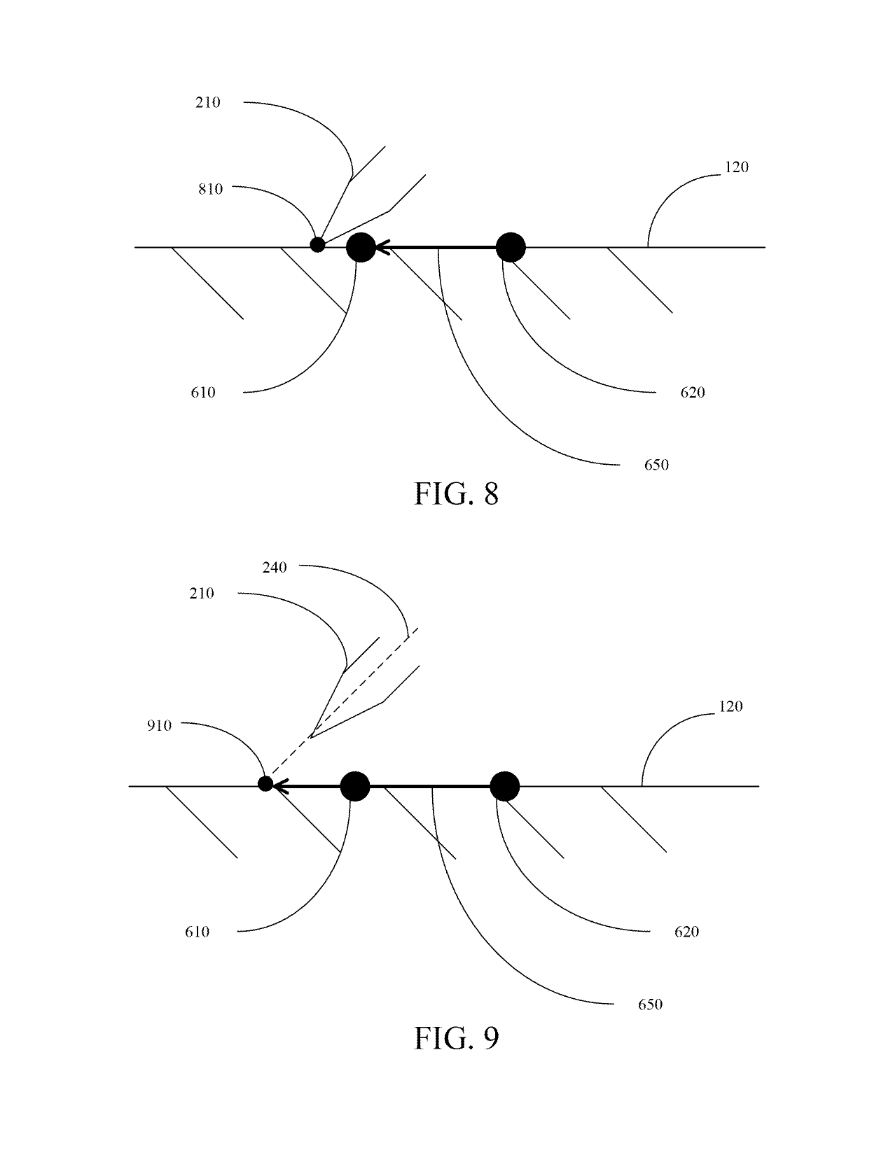

Please refer to FIG. 8, which depicts a magnified view near the touch point of the tip electrode 210 as shown in FIG. 7. For convenience, the shielding ring 220 and the axis 240 are omitted in FIG. 8. As shown in FIG. 8, the tip position 810 where in the tip electrode 210 touches the touch screen 120 is not overlapped with the first position 610. Because the first position 610 is the gravity or the mess center of the first influential area 630 of the electrical signals emitted from the tip electrode 210. The first position 610 is positioned a little backward. The error between the first position 610 and the tip position 810 varies according to the change of the inclination angle 250.

In one embodiment, the touch sensitive processing apparatus may calculate a new vector by multiplying the vector 650 with a functional value according to the length of the vector 650. The functional value is corresponding to the length of the vector 650. The tip position of the new vector is at the tip position 810.

Please refer to FIG. 9, which depicts a variant of the embodiment as shown in FIG. 8. Comparing with the embodiment as shown in FIG. 8, the tip electrode 210 does not touch the surface of the touch screen 120. As discussed above, the touch sensitive processing apparatus 110 may be aware of the pressure on the tip electrode 210 is zero from the information carried by the electric signals. Or the touch sensitive processing apparatus 110 may be aware of that no pressure is detected near the first position 610 or the second position 620 of the touch screen 120 via the touch electrodes of the touch screen 120. Hence, the touch sensitive processing apparatus 110 may use a second function such that a new vector would be obtained by multiplying the length of the vector 650 with a value of the second function, where the value of the second function is related to the length of the vector 650 and the inclination angle 250. The tip position of this new vector is a position where the extension of body axis 240 intersects with the touch screen 120.

Because the tip electrode 210 is not in contact with the surface of the touch screen 120, the touch sensitive processing apparatus 110 may use a estimate value to represent a distance between the tip of the active stylus and the touch screen 120. In one embodiment, it may be assumed that the signal strength of the electric signals emitted from the active stylus 130 is consistent. When the distance between the tip electrode 210 and the touch screen 120 changes, the touch sensitive processing apparatus 110 may compare the sum of strengths of electric signals near the first position 610 during the first period 630 with the predetermined sum of strengths of electric signals and obtain an estimated distance according to the differences of these two sums. Since the inclination angle 250 can be calculated according to the length of the vector 650 and the estimated distance between the tip electrode 210 and the touch screen 120 can be calculated, the extended position 910 where the extension of body axis 240 intersects with the touch screen 120 can be obtained.

In an alternative example, in the step of signal strength comparison, the sum of signal strengths near the first position 610 and the second position 620 during the first period 630 and the second period 640 can be used to compared with the predetermined sum of strengths of electric signals and obtain an estimated distance according to the differences of these two sums. In these embodiments, the summation may be performed on those signal strengths exceeding a threshold to filter out the signal strength is less than the threshold.

In an embodiment, when the sum of the signal strengths is less than a sum threshold, it implies that the distance between the active stylus 130 and the touch screen 120 is too far. Thus, the estimated distance may be set as a constant number which may represent a maximum number or a ceiling of the estimated distance.

Since the extended position 910 is located beyond the area where the active stylus 130 being projected on the touch screen 120, the extended position 910 can be easily saw by the user. The line-of-sight would not be interfered by the active stylus 130.

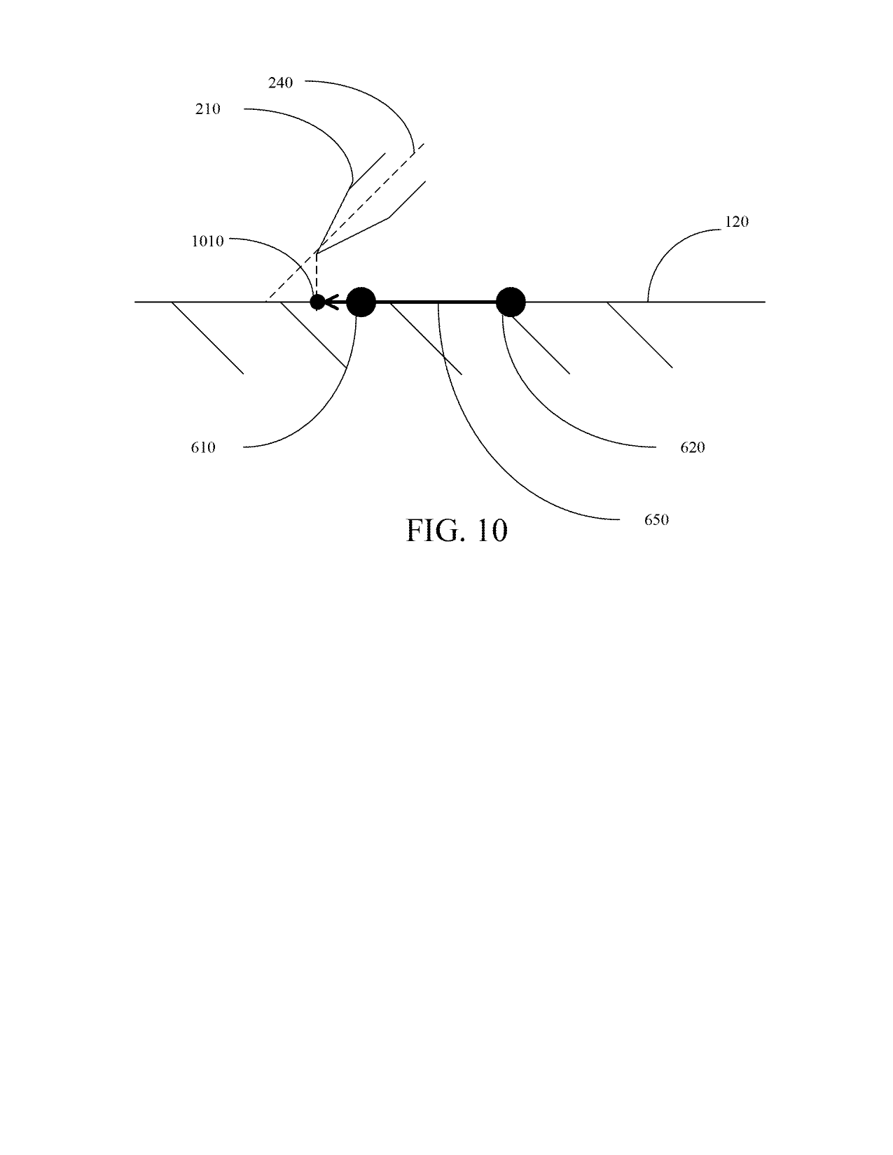

Please refer to FIG. 10, which is a variant of the embodiment as shown in FIG. 9. Comparing with the embodiment as shown in FIG. 9, a projected point 1010 calculated by the touch sensitive processing apparatus 110 is shown. The projected point 1010 is the location where the tip being vertically projected to the touch screen 120. In other words, a normal line perpendicular to the touch screen 120 departing from the projected point 1010 would pass through the tip of the tip electrode 210.

When the location where the tip is corresponding to the touch screen 120 remains, no matter what the inclination angle 250 is, the projected point 1010 does not move. As discussed above, the touch sensitive processing apparatus 110 may be aware of the pressure on the tip electrode 210 is zero from the information carried by the electric signals. Or the touch sensitive processing apparatus 110 may be aware of that no pressure is detected near the first position 610 or the second position 620 of the touch screen 120 via the touch electrodes of the touch screen 120. Hence, the touch sensitive processing apparatus 110 may use a third function such that a new vector would be obtained by multiplying the length of the vector 650 with a value of the third function, where the value of the third function is related to the length of the vector 650. The tip position of this new vector is a position where the tip being vertically projected to the touch screen 120.

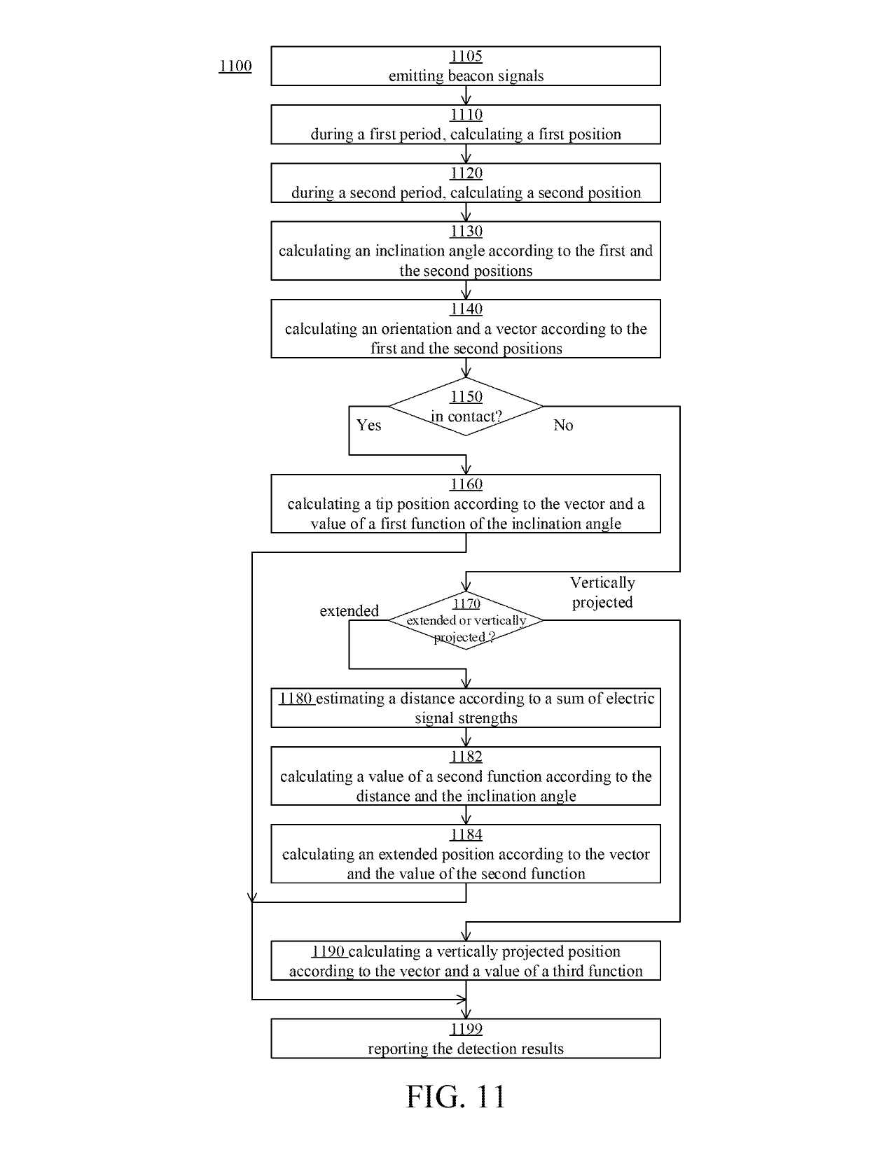

Please refer to FIG. 11, which depicts a flowchart diagram of a method 1100 for detecting position where active stylus approaches or touches in accordance with an embodiment of the present application. The method 1100 for detecting position where active stylus approaches or touches may be realized by the touch sensitive processing apparatus 110 and the touch screen 120 as shown in FIG. 1. Especially, it may be realized by executing multiple instructions stored in non-volatile memory by the processor module 114. If there is no direct or indirect causal relationship between any two steps, the present application does not limit the execution sequence. The method 1100 for detecting position where active stylus approaches or touches may begin at step 1105 or step 1100.

Step 1105: during a beacon signal period 525, emitting beacon signals via at least one touch electrode.

Step 1110: during a first period 530, detecting electrical signals via multiple touch electrodes of the touch screen to calculate a first position 610.

Step 1120: during a second period 540, detecting electric signals via multiple touch electrodes of the touch screen to calculate a first position 620.

Step 1140: according to the first position and the second position, calculating an inclination angle 250 of the active stylus 130.

Step 1140: according to the first position and the second position, calculating an orientation and its vector 650.

Step 1150: determining whether a tip of the active stylus 130 touches the touch screen 120. As discussed above, the touch sensitive processing apparatus 110 may demodulate the electric signals to know whether the tip electrode 210 of the active stylus 130 receives pressure. Thus, it can determine whether the tip of the active stylus 130 touches the touch screen 120. In an alternative embodiment, when the touch screen 120 has pressure detection function, the touch sensitive processing apparatus 110 may determine whether the tip of the active stylus 130 touches the touch screen 120 according to whether pressure is detected near the first position 610, the second position 620, and/or somewhere in between. When it is determined that the tip of the active stylus 130 touches the touch screen 120, the flow proceeds to step 1160. When it is determined that the tip of the active stylus 130 is clear of the touch screen 120, the flow proceeds to step 1170.

Step 1160: according to the vector 650 and a value of a fist function of the inclination angle 250, calculating a tip position, i.e., the tip position 810 in the embodiment as shown in FIG. 8. Next, the flow proceeds to step 1199.

Step 1170: determining which one of the extended position 910 and the vertically projected position 1010 is required by the host 140. When the extended position 910 is required by the host 140, the flow proceeds to step 1180. When the vertically protected position 1010, the flow proceeds to step 1190.

Step 1180: estimating a distance between the tip and the touch screen 120 according to a sum of electric signal strengths related to the first position 610 and/or the second position 620.

Step 1182: calculating a value of a second function according to the distance and the inclination angle 250. The value of the second function is a multiple of the vector 650. In an alternative embodiment, the value of the second function is an extension of the vector 650. Or the value of the second function may be equivalent to a second vector departing from the first position 610. The direction of the second vector and the direction of the vector 650 is identical.

Step 1184: calculating the extended position 910 based on the vector 650 and the value of the second function. Next, the flow proceeds to step 1199.

Step 1190: calculating the vertically projected position 1010 of the tip according to the vector 650 and the value of the third function.

Step 1199: reporting the detection results to the host 140. The detection results may include one or any combination of following: the first position 610; the second position 620; the orientation; the vector 650; the inclination angle 250; the tip position 810; the extended position 910; and the vertically projected position 1010.

In one embodiment, when the host 140 requests the extended position 910 and the vertically projected position 1010, the step 1170 can be skipped. The method 1100 for detecting position where active stylus approaches or touches may include step 1180 and step 1190.

In one embodiment, the touch sensitive processing apparatus 110 may just perform step 1110 and step 1120. And at step 1199, it provides the first position 610 and the second position 620 to the host 140. The host 140 may further realize the rest steps of the method 1100 for detecting position where active stylus approaches or touches. The present application does not limit that the steps 1140 through 1190 must be done by the touch sensitive processing apparatus 110. The steps 1140 through 1190 may be performed by either the touch sensitive processing apparatus 110 or the CPU 142.

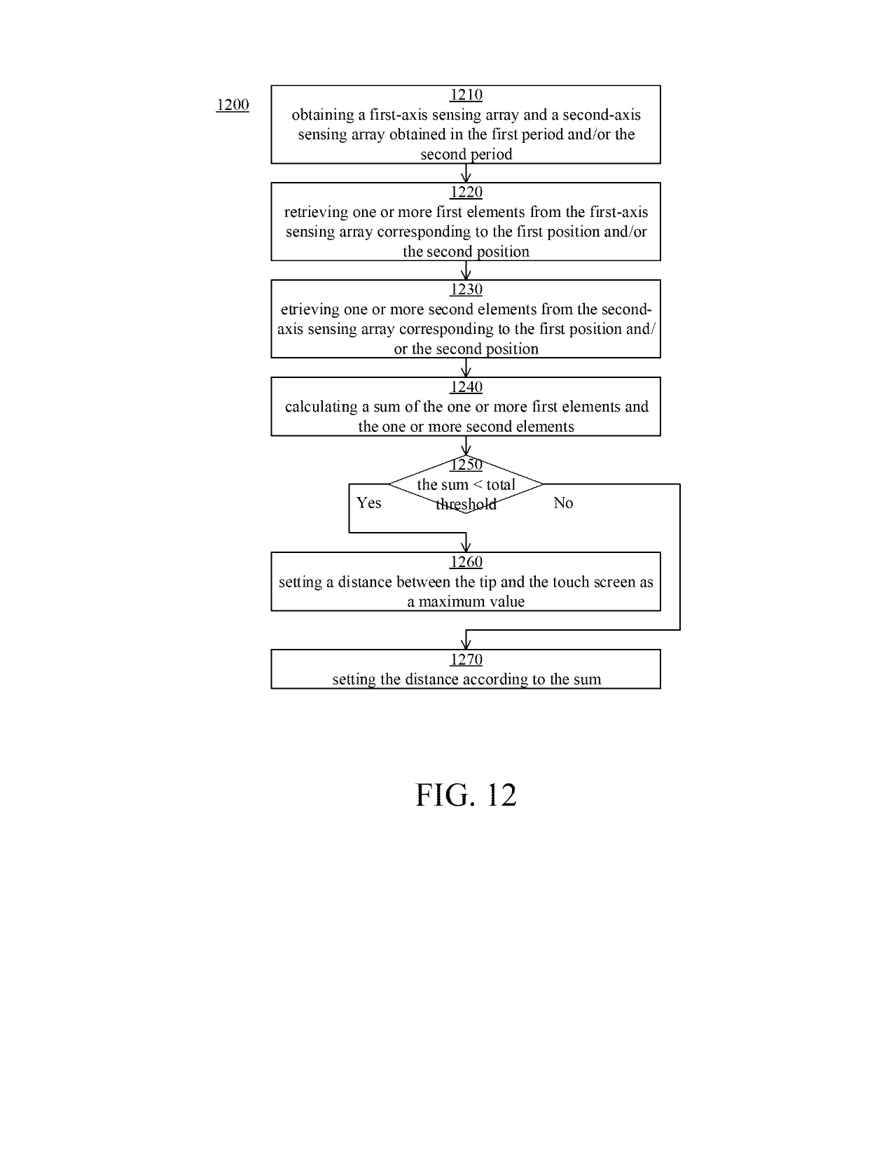

Please refer to FIG. 12, which depicts a flowchart diagram of a method 1200 for estimating a distance between a tip and a touch screen in accordance with an embodiment of the present application. The method 1200 for estimating a distance between a tip and a touch screen may be an embodiment of the step 1180 as shown in FIG. 11. If there is no direct or indirect relationship between any two steps, the present application does not limit the execution sequence of the two steps. The method 1200 for estimating a distance between a tip and a touch screen may be corresponding to one of the first period and the second period. Or alternatively, it may be corresponding to both the first period and the second period. The method 1200 may begin at step 1210.

Step 1210: obtaining a first-axis sensing array and a second-axis sensing array obtained in the first period and/or the second period. These sensing arrays may come from the step 1110 and/or the step 1120 as shown in FIG. 11.

Step 1220: retrieving one or more first elements from the first-axis sensing array corresponding to the first position and/or the second position. In one embodiment, when the value of the first element is less than a threshold, the first element may be discarded.

Step 1230: retrieving one or more second elements from the second-axis sensing array corresponding to the first position and/or the second position. In one embodiment, when the value of the second element is less than the threshold, the second element may be discarded.

Step 1240: calculating a sum of the one or more first elements and the one or more second elements. Next, the flow may proceed to optional step 1250 or directly to step 1270.

Step 1250: determining whether the sum exceeds a sum threshold. When the sum is less than the sum threshold, the flow proceeds to step 1260. Instead, when the sum is larger than the sum threshold, the flow proceeds to step 1270.

Step 1260: setting a distance between the tip and the touch screen as a maximum value.

Step 1270: setting the distance according to the sum. When the sum gets larger, the distance gets smaller. Instead, when sum gets smaller, the distance gets larger. However, the relation between the sum and the distance may be non-linear. A predetermined table may be used to correspond the distance and the sum. Alternatively, a function of the sum may be used to calculate the distance.

According to an embodiment of the present application, a method for detecting position where active stylus approaches or touches is provided. The method comprising: detecting electric signals via multiple touch electrodes of a touch screen during a first period for calculating a first position of an active stylus; detecting electric signals via the multiple touch electrodes of a touch screen during a second period for calculating a second position of the active stylus; calculating an inclination angle between the active stylus and the touch screen according to the first position and the second position; calculating an orientation and its vector according to the first position and the second position; and when a tip of the active stylus touches the touch screen, calculating a tip position according to the vector and a value of a first function of the inclination angle.

Preferably, in order to determine whether a tip of the active stylus is in contact with the touch screen, the method further comprises one of following steps to determine whether a tip of the active stylus is in contact with the touch screen: demodulating the electric signals to obtain pressure information on a tip of the active stylus; and determining whether the touch screen is pressed near the first position according to a mutual capacitance sensing image of the multiple touch electrodes.

Preferably, in order to obtain a projected position when the active stylus floating on the touch screen, the method further comprises: when the tip of the stylus is not in contact with the touch screen, calculating a vertically projected position of the tip according to the vector and a value of a third function.

Preferably, in order to obtain a projected position when the active stylus floating on the touch screen, wherein when the tip of the stylus is not in contact with the touch screen, the method further comprises: estimating a distance between the tip and the touch screen according to a sum of the electric signals; calculating a value of a second function according to the distance and the inclination angle; and calculating an extended position where a body axis of the active stylus intersects with the touch screen according to the vector and the value of the second function.

Preferably, in order to estimate the distance between the tip and the touch screen, wherein the method further comprises: obtaining a first-axis sensing array via multiple second electrodes in parallel of the multiple touch electrodes and a second-axis sensing array via multiple first electrodes in parallel of the multiple touch electrodes during the first period; retrieving one or more first elements from the first-axis sensing array related to the first position; retrieving one or more second elements from the second-axis sensing array related to the first position; calculating a sum of the one or more first elements and the one or more second elements; and setting the distance between the tip and the touch screen according to the sum.

Preferably, in order to estimate the distance between the tip and the touch screen, wherein the method further comprises: setting the distance between the tip and the touch screen as a maximum, when the sum is less than a sum threshold.

Preferably, in order to filter out interferences from noises, wherein the values of the one or more first elements and the values of the one or more second elements exceed a threshold.

Preferably, in order to estimate the distance between the tip and the touch screen more thoughtfully, wherein the method further comprises: obtaining a second-period first-axis sensing array via the multiple second electrodes in parallel of the multiple touch electrodes and a second-period second-axis sensing array via the multiple first electrodes in parallel of the multiple touch electrodes during the second period; retrieving one or more first elements from the second-period first-axis sensing array related to the second position; and retrieving one or more second elements from the second-period second-axis sensing array related to the second position.

According to an embodiment of the present application, a touch system for detecting position where active stylus approaches or touches is provided. The touch system comprising the touch sensitive processing apparatus; the touch screen; and the active stylus.

The stylus and corresponding touch sensitive processing apparatus and method of the present application provide that the active stylus selectively lets potential of the shielding ring surrounding the tip electrode being floating or grounded when the electrical signals continuously emitted by the tip electrode of the active stylus. As a result, the touch sensitive processing apparatus can calculate an inclination angle between the active stylus and the touch screen and a direction or an orientation the active stylus projected on the touch screen according to two positions caused by the change of the potential of the shielding ring. Moreover, a tip position of the active stylus can be more precisely calculated according to the inclination angle of the touch screen. Because the user more easily sees the extended position or the vertically projected position of the tip, unlike the line-of-sight to the first position or the tip position may be blocked by the active stylus or the finger. Thus, it can provide better user experience.

Because the active stylus only has to control the potential of the shielding ring being floating or grounded and the electrical signals are continuously emitted from the tip electrode, the relevant circuit design would be simplified to reduce manufacturing cost. Moreover, because the circuit design is simpler, the active stylus is more shock resistant and drop resistant, the user may think that the active stylus more robust, durable, and reliable.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for detecting position where active stylus approaches or touches, comprising:
detecting electric signals via multiple touch electrodes of a touch screen during a first period for calculating a first position of an active stylus;
detecting electric signals via the multiple touch electrodes of the touch screen during a second period for calculating a second position of the active stylus;
calculating an inclination angle between the active stylus and the touch screen according to the first position and the second position;
calculating an orientation and its vector according to the first position and the second position; and
when a tip of the active stylus touches the touch screen, calculating a tip position according to the vector and a value of a first function of the inclination angle.

2. The method for detecting position where active stylus approaches or touches as recited in claim 1, further comprises one of following steps to determine whether a tip of the active stylus is in contact with the touch screen:
demodulating the electric signals to obtain pressure information on a tip of the active stylus; and
determining whether the touch screen is pressed near the first position according to a mutual capacitance sensing image of the multiple touch electrodes.

3. The method for detecting position where active stylus approaches or touches as recited in claim 1, further comprises when the tip of the stylus is not in contact with the touch screen, calculating a vertically projected position of the tip according to the vector and a value of a third function.

4. The method for detecting position where active stylus approaches or touches as recited in claim 1, wherein when the tip of the stylus is not in contact with the touch screen, the method further comprises:
estimating a distance between the tip and the touch screen according to a sum of the electric signals;
calculating a value of a second function according to the distance and the inclination angle; and
calculating an extended position where a body axis of the active stylus intersects with the touch screen according to the vector and the value of the second function.

5. The method for detecting position where active stylus approaches or touches as recited in claim 4, further comprises:
obtaining a first-axis sensing array via multiple second electrodes in parallel of the multiple touch electrodes and a second-axis sensing array via multiple first electrodes in parallel of the multiple touch electrodes during the first period;
retrieving one or more first elements from the first-axis sensing array related to the first position;
retrieving one or more second elements from the second-axis sensing array related to the first position;
calculating a sum of the one or more first elements and the one or more second elements; and
setting the distance between the tip and the touch screen according to the sum.

6. The method for detecting position where active stylus approaches or touches as recited in claim 5, further comprises setting the distance between the tip and the touch screen as a maximum, when the sum is less than a sum threshold.

7. The method for detecting position where active stylus approaches or touches as recited in claim 5, wherein the values of the one or more first elements and the values of the one or more second elements exceed a threshold.

8. The method for detecting position where active stylus approaches or touches as recited in claim 5, further comprises:
obtaining a second-period first-axis sensing array via the multiple second electrodes in parallel of the multiple touch electrodes and a second-period second-axis sensing array via the multiple first electrodes in parallel of the multiple touch electrodes during the second period;
retrieving one or more first elements from the second-period first-axis sensing array related to the second position; and
retrieving one or more second elements from the second-period second-axis sensing array related to the second position.

9. A touch sensitive processing apparatus for detecting position where active stylus approaches or touches, comprising:
an interconnection network module for connecting multiple touch electrodes of a touch screen, respectively;
a sensing circuit module for detecting electric signals via the multiple touch electrodes through the interconnection network module; and
a processor module for executing instructions stored in non-volatile memory to realize:
having the sensing circuit module detect electric signals via multiple touch electrodes of a touch screen during a first period for calculating a first position of an active stylus;
having the sensing circuit module detect electric signals via the multiple touch electrodes of a touch screen during a second period for calculating a second position of the active stylus;
calculating an inclination angle between the active stylus and the touch screen according to the first position and the second position;
calculating an orientation and its vector according to the first position and the second position; and
when a tip of the active stylus touches the touch screen, calculating a tip position according to the vector and a value of a first function of the inclination angle.

10. The touch sensitive processing apparatus as recited in claim 9, wherein the processor module is further configured to realize one of following to determine whether a tip of the active stylus is in contact with the touch screen:
demodulating the electric signals to obtain pressure information on a tip of the active stylus; and
determining whether the touch screen is pressed near the first position according to a mutual capacitance sensing image of the multiple touch electrodes.

11. The touch sensitive processing apparatus as recited in claim 9, wherein the processor module is further configured for when the tip of the stylus is not in contact with the touch screen, calculating a vertically projected position of the tip according to the vector and a value of a third function.

12. The touch sensitive processing apparatus as recited in claim 9, wherein when the tip of the stylus is not in contact with the touch screen, the processor module is further configured for:
estimating a distance between the tip and the touch screen according to a sum of the electric signals;
calculating a value of a second function according to the distance and the inclination angle; and
calculating an extended position where a body axis of the active stylus intersects with the touch screen according to the vector and the value of the second function.

13. The touch sensitive processing apparatus as recited in claim 12, wherein the processor module is further configured for:
obtaining a first-axis sensing array via multiple second electrodes in parallel of the multiple touch electrodes and a second-axis sensing array via multiple first electrodes in parallel of the multiple touch electrodes during the first period;
retrieving one or more first elements from the first-axis sensing array related to the first position;
retrieving one or more second elements from the second-axis sensing array related to the first position;
calculating a sum of the one or more first elements and the one or more second elements; and
setting the distance between the tip and the touch screen according to the sum.

14. The touch sensitive processing apparatus as recited in claim 12, wherein the processor module is further configured for setting the distance between the tip and the touch screen as a maximum, when the sum is less than a sum threshold.

15. The touch sensitive processing apparatus as recited in claim 12, wherein the values of the one or more first elements and the values of the one or more second elements exceed a threshold.

16. The touch sensitive processing apparatus as recited in claim 12, wherein the processor module is further configured for:
obtaining a second-period first-axis sensing array via the multiple second electrodes in parallel of the multiple touch electrodes and a second-period second-axis sensing array via the multiple first electrodes in parallel of the multiple touch electrodes during the second period;
retrieving one or more first elements from the second-period first-axis sensing array related to the second position; and
retrieving one or more second elements from the second-period second-axis sensing array related to the second position.

17. A touch system for detecting position where active stylus approaches or touches is provided, comprising the touch sensitive processing apparatus; the touch screen; and the active stylus as recited in claim 9.
